(19) United States
(12) Patent Application Publication
(10) Pub. No.: US 2013/0198481 A1
(43) Pub. Date: Aug. 1, 2013

(54) USB Stick

(71) Applicant: Siemens Aktiengesellschaft, Muenchen (DE)

(72) Inventors: Patrik GANDER, Herxheim (DE); Rene Giraud, Eggenstein-Leopoldshafen (DE); Rainer Paul, Kapsweyer (DE); Reiner Schäfer, Graben-Neudorf (DE)

(73) Assignee: Siemens Aktiengesellschaft, Muenchen (DE)

(21) Appl. No.: 13/754,556

(22) Filed: Jan. 30, 2013

(30) Foreign Application Priority Data
Feb. 1, 2012 (EP) EP12153479

(51) Int. Cl. G06F 12/06

(52) U.S. Cl. CPC G06F 12/0646
USPC 711/170

(57) ABSTRACT

A USB stick for connection to electronic devices that are provided with a USB interface, wherein the USB stick includes a memory. Suitable measures are used to allow the USB stick to be used in different electronic devices, with virtual USB sticks being set up on the memory of the USB stick and each virtual USB stick representing an independent USB stick for a device.

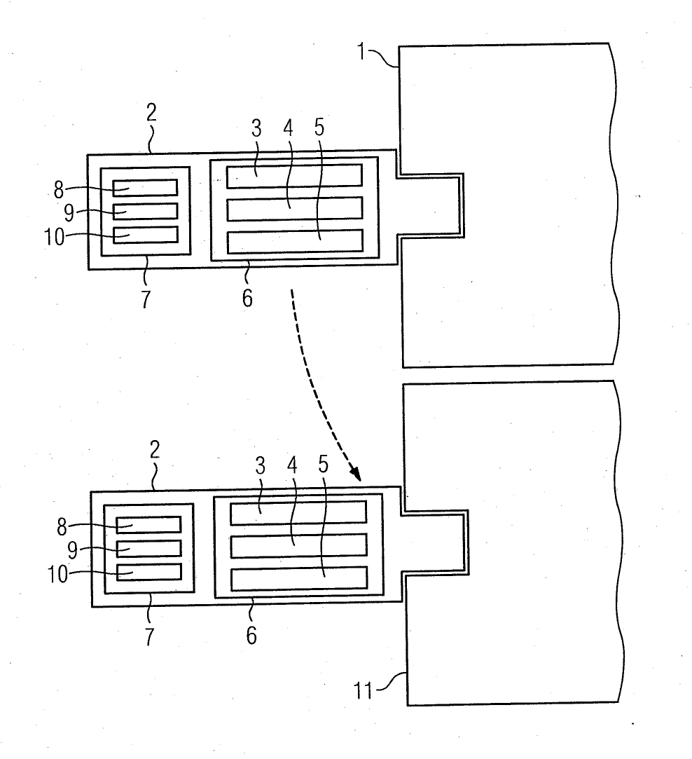

### BACKGROUND OF THE INVENTION

1. Field of the Invention

The invention relates to a USB stick for connection to electronic devices which are provided with a USB interface, where the USB stick includes a memory.

2. Description of the Related Art

In general, USB sticks are known and are provided for different applications. For example, USB sticks in the form of USB memory sticks are used as mass memories for storing different operating systems or other data, where these USB sticks frequently are formatted differently for the different applications. Particularly, a service engineer finds “handling” this multiplicity of sticks awkward, in particular the field of application of such USB sticks is constantly increasing or expanding.

### SUMMARY OF THE INVENTION

It is therefore an object of the invention to provide a USB stick that allows use in different electronic devices.

This and other objects and advantages are achieved in accordance with the invention by providing a USB stick that is configured to use a configuration mode of operation to set up at least one area of the memory in the USB stick for each electronic device and to associate a prescribed piece of information for presentation on a display of the USB stick with the respective at least one area, and to respond to selection of one of the prescribed pieces of information by an operator by enabling the at least one area of the memory in the USB stick that is associated with this selected piece of information for access by the respective electronic device.

The invention is based on the concept of setting up virtual USB sticks on the memory of the USB stick, where each virtual USB stick is provided for one application or for one electronic device. A virtual USB stick for a device represents an independent USB stick for this device that becomes “visible” or is recognized on the USB port of the device. By contrast, all further virtual USB sticks are not “visible” to this device, and the device cannot effect read and/or write access to these further USB sticks.

In one embodiment of the invention, the USB stick is configured to present the information as pictograms, and for the USB stick to have a touch screen for the presentation and selection of the pictograms. This makes it easier for a user to select one of the virtual USB sticks.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWING

The invention is explained in more detail below using an exemplary embodiment with reference to the single FIGURE of the drawing, in which:

The FIGURE shows an arrangement having electronic devices and a USB stick in highly simplified form.

### DETAILED DESCRIPTION OF THE PREFERRED EMBODIMENTS

Reference designator 1 denotes an electronic device that comprises a laptop in which a USB stick 2 has been plugged into a USB port on the laptop 1. The laptop 1 has a program (not shown) which a user or operator uses in a configuration mode of operation to set up areas 3, 4, 5 of a memory 6 of the USB stick 2 for use in further electronic devices or for various applications. The configuration program, which is activated by a switch or pushbutton switch (not shown) on the USB stick, may naturally be provided with password protection, which means that the memory areas 3, 4, 5 or further memory areas (not shown) can be set up only when the operator is able, following a request, to input the correct password into an input field provided for the purpose on a display of the laptop 1. By way of example, the memory area 3 is provided for the purpose of storing multimedia files, where the memory area 4 is provided for the purpose of storing an operating system and the memory area 5 is provided for a piece of software or for other data. The memory areas 3, 4, 5, which have been set up in this manner the configuration program, represent three virtual USB sticks, the capacities of which can naturally be chosen to be different via the configuration program. By way of example, the areas 3, 4, 5 can be implemented as virtual 5, 10 or 20 GByte USB sticks, with the total capacity of the USB stick 2 naturally corresponding to at least the sum of the capacities of the virtual USB sticks.

It may be necessary to format the memory areas 3, 4, 5 or the virtual USB sticks differently to be able to use or operate them in different devices.

When an electronic device into which the USB stick is intended to be inserted does not require the USB stick to be formatted, it is sufficient to use the configuration program on the laptop 1 to set up only the size of one of the virtual USB sticks, e.g., the size of the memory area 4 with a capacity of 15 GBytes. In this case, this memory area 4 is then formatted using a suitable formatting program of the electronic device into and in which the USB stick is intended to be inserted and operated.

When, by contrast, one of the memory areas 3, 4, 5 (virtual USB stick) of the USB stick can be accessed by an electronic device only if this area is already formatted in a suitable fashion, the operator or user uses the configuration program on the laptop 1 to set up one of the memory areas 3, 4, 5 based on a prescribed size and based on formatting that is determined or required by the electronic device, such as FAT32 formatting. Only then is there the assurance that the electronic device can access this virtual USB stick that has been set up in this manner when the USB stick is plugged into the device.

The configuration program associates a pictogram with each of the three memory areas 3, 4, 5, where the pictogram is presented or displayed on a mini display, an OLED display, an electronic paper display or a mini touch screen 7 of the USB stick in each case. In the present exemplary embodiment, the memory areas 3, 4, 5 have associated pictograms 8, 9, 10, with a rechargeable energy source (not shown) of the USB stick 2 meaning that there is the assurance that the pictograms 8, 9, 10 are still displayed to the user even when the USB stick 2 has been removed from the laptop 1. So long as the USB stick 2 is plugged into the laptop 1 or into another electronic device provided with a USB interface, this energy source is charged.

It is subsequently assumed that a user has copied files for an operating system, e.g., what is known as a Linux operating system, from a hard disk in a laptop 1 to the memory area 4 of the USB stick 2 and has stored them therein. It is also assumed that the USB stick 2 has been removed from the USB port on the laptop 1 and been plugged into a USB port on a desktop PC 11, as indicated by a dashed line in the drawing. From this USB stick 2, the operating system stored in the memory area 4 can be “booted” or started for this desktop PC 11. In order to accomplish this, the user selects the pictogram 9 associated with this virtual USB stick or with this memory area 4 by virtue of the user touching this pictogram 9. By way of example, the pictogram 9 may be an image of the known “Linux penguin”. Based on this touch, a program or a firmware routine on the USB stick 2 enables the memory area 4 for access by the desktop PC 11, and the operating system is booted for the desktop PC 11. The further virtual USB sticks, i.e., the memory areas 3 and 5, are not accessible to the desktop PC 11. When data are stored therein, they therefore cannot be lost and also cannot be changed.

Hence, the invention can be summarized as follows: a USB stick 2 for connection to electronic devices 11 which are provided with a USB interface, where the USB stick 2 has a memory 6, is configured to use a configuration mode of operation to set up at least one area 3, 4, 5 of the memory 6 in the USB stick 2 for each electronic device 11 and to associate a prescribed piece of information 8, 9, 10 for presentation on a display 7 of the USB stick 2 with the respective at least one area 3, 4, 5, and to respond to selection of one of the prescribed pieces of information 8, 9, 10 by an operator by enabling the at least one area 3, 4, 5 of the memory 6 in the USB stick 2 which is associated with this selected piece of information 8, 9, 10 for access by the respective electronic device 11. As a result, the USB stick 2 is suitable for use in different electronic devices provided with a USB interface.

While there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A USB stick for connection to electronic devices which are provided with a USB interface, wherein the USB stick includes a memory, and wherein the USB stick is configured to utilize a configuration mode of operation to set up at least one area of the memory in the USB stick for each electronic device and to associate a prescribed piece of information for presentation on a display of the USB stick with a respective at least one area, and to respond to selection of the prescribed piece of information by an operator by enabling the at least one area of the memory in the USB stick associated with the selected a prescribed piece of information for access by a respective electronic device.

2. The USB stick as claimed in claim 1, wherein the USB stick is further configured to present the prescribed piece of information as pictograms, and wherein the USB stick includes a touch screen for presentation and selection of the pictograms.
